(19) United States
(12) Patent Application Publication
(10) Pub. No.: US 2007/0019403 A1
(43) Pub. Date: Jan. 25, 2007

(54) Portable lighting apparatus

(76) Inventor: Hratch Paul Boghossian, Glendale, CA (US)

Correspondence Address: Kevin Prince, 28812 Woodcock Dr., Laguna Niguel, CA, 92677, US

(21) Appl. No.: 11/184,182

(22) Filed: Jul. 19, 2005

(51) Int. Cl. F21L 4/00

(52) U.S. Cl. 362/157

(57) ABSTRACT

A portable lighting apparatus and a method of its use are disclosed. A mounting post is vertically supported by a rigid base which includes a plurality of wheels fixed to a bottom side thereof The base further includes an enclosure which completely encloses the mounting post, as well as the other components of the invention, when the apparatus is in a disassembled configuration. A mast is preferably comprised of at least one elongated mast section, each of which fit end-to-end and can be locked together. The mast is fixed to the mounting post. A light fixture is included that comprises a lamp post, a port plug, and a lamp holder mount that supports a lamp holder. The lamp post has a lower end that is attachable to the upper end of any one of the plurality of mast sections. A lamp bulb is held by the lamp holder, and a connector cable is electrically connected to the bulb therethrough. A unitary inflatable non-opaque balloon is included that comprises a flexible, generally spherical sheet material and an open port. The open port provides an opening into the balloon for hermetically receiving the light fixture therein. A stabilizing base is included that has a center opening slidably engageable with the lamp post of the light fixture. As such, the balloon may be fastened securely to the mast through at least one fastening strap and the stabilizing base. A power source is included for the bulb, and an air blower may be included for inflating the balloon during assembly. A method of use of the apparatus is also disclosed.

### FIELD OF THE INVENTION

This invention relates to illumination devices, and more particularly to a portable lighting apparatus for temporary illumination so as to facilitate completion of a construction project, provide emergency or temporary outdoor lighting, or the like.

### DISCUSSION OF RELATED ART

Various devices have been invented for providing temporary lighting in such environments as construction projects, parking lots, underground tunnels, sporting events, and the like. Several such devices include an inflatable balloon that is illuminated from within to provide a light source that, while diffuse, still provides considerable illumination of the surrounding area. The present invention falls into this category, yet overcomes some of the disadvantages of the prior art devices of its type.

For example, US Patent Application 2005/0063189 to Ossolinski, published on Mar. 24, 2005, discloses such a device mounted on a towed trailer. One benefit listed in the Ossolinski application is that the device only weighs 1,000 KG. While this may be considered light-weight compared to other prior art devices, the user of such a device would always need a vehicle to tow it to its desired location, making it unsuitable for use in situations where road access is not available. Further, the Ossolinski device contemplates an embodiment having a rigid envelope or balloon, but such a device is inconvenient to store and transport. Further, both the rigid and the inflated balloon embodiments require a continuous air blower to keep the bulb cool or to keep the inflated balloon from deflating. Such continuous operation is excessively noisy for certain lighting situations, such as outdoor golfing or evening outdoor entertainment.

U.S. Pat. No. 6,012,826 likewise discloses an illuminating balloon with a continuously running electropneumatic blowing device for keeping the balloon thereof inflated.

US Patent Application 2004/0170022 to Yoshimori et al. discloses a similar device that includes a generator at the base of an extendable supporting column for supporting its illuminated balloon. A generator certainly is excessively noisy, and must be run while the device is being used. Further, louvers of the Yoshimori device serve simply to block light in an unwanted direction, but they do not redirect such light, and as such this apparatus is not nearly as efficient as it could be.

Another such device, disclosed in U.S. Pat. No. 4,542,445 to Marietta on Sep. 17, 1985, discloses an electric light balloon that is meant to be held and manually actuated. The lamp in such a device is set quite low in the balloon, and thus even illumination of the balloon surface does not occur, resulting in a “hot spot” towards the bottom which will result in a unacceptable glare if a high-intensity bulb is used. Further, activation of the such a device causes the balloon to expand, and deactivation causes the balloon to deflate. While meant more as a novelty item, the design of such a device cannot be extended to a more robust product suitable for industrial use due to these drawbacks. A pole-mounted park light fixture is disclosed in U.S. Pat. No. 5,483,432 to Wang on Jan. 9, 1996. Such a device includes a lamp hood that is presumably a rigid structure, and thus has the drawbacks of not being easily transported or stowed.

U.S. Pat. No. 6,769,794 to Huang on Aug. 3, 2004 discloses another decorative lamp that includes a soft cover for the bulb, but further includes a shell around the bulb to prevent the bulb from contacting the soft cover in the event of deflation of the soft cover. Such a shell, however, is unsuitable for high-intensity bulbs, as it is apparently made of a plastic material. No information is given on the inflation means of such a device, which appears to be for decorative use more than industrial or high-intensity uses.

Clearly there is a need for a portable lighting apparatus that provides essentially silent operation while still providing high-intensity illumination for a large area, yet does not result in glare that is often caused by direct high-intensity lighting. Such a needed devices would be easy to set-up and disassemble, easy to store and transport, and would be made of relatively inexpensive components. Further, such a needed device would be adjustable to a variety of heights, allow for a wide variety of uses both indoors and outdoors, and not require roadway access to the desired location of use. Still further, such a device would be light weight, safe for extended use, and versatile in its mounting configurations. The present invention accomplishes these objectives.

### SUMMARY OF THE INVENTION

The present device is a portable lighting apparatus suitable for use at an outdoor construction site, underground tunnel, or other area where temporary illumination is desired. A mounting post is supported by a base which is, in its simplest form, a metal plate. Preferably, however, the base is made from a rigid metallic material and includes a plurality of wheels fixed to a bottom side thereof. The mounting post is fixed to the base with a mounting plate that is bolted to the base, welded thereto, or fixed in some other permanent manner. The base further includes an enclosure which completely encloses the mounting post, as well as the other components of the invention when the apparatus is in a disassembled configuration.

The mast is preferably comprised of a plurality of elongated mast sections that fit end-to-end and can be locked together. In this manner the desired height of the mast is obtained by choosing the desired number of mast sections. The mounting post includes a top portion pivotally attached to a bottom portion. In use, the lower end of the lower-most mast segment is positioned around the top portion of the mounting post, such that the mast is maintained in a generally horizontal position. When the user is ready to raise the mast, the top-most end of the mast is raised, pivoting the top portion, until the top portion is substantially vertical. As such, the mast drops down until it contacts either a backstop fixed to the bottom of the mast, or the base. The rigidity of each of the mast segments prevents further pivoting of the mounting post, thereby maintaining the mast in a generally orthogonal orientation to the base.

A light fixture is included that comprises a lamp post, a port plug, and a lamp holder mount that supports a lamp holder. The lamp post has a lower end that is attachable to the upper end of any one of the plurality of mast sections. The port plug is a generally circular disk that includes a one-way air valve, as well as support for the lamp holder mount and the lamp post. Other than for the one-way air valve, the port plug as an assembly is impermeable to air. A lamp bulb is held by the lamp holder, and a connector cable is electrically connected to the bulb therethrough.

A unitary inflatable non-opaque balloon is included that comprises a flexible, generally spherical sheet material and an open port. The open port provides an opening into the balloon for hermetically receiving the light fixture therein. In the preferred embodiment of the invention, the balloon is made from a unitary piece of vinyl material and is initially either rotationally molded or blow molded, and then while still warm from its manufacturing process, is injected with air to further expand its size.

A stabilizing base is preferably included that has a center opening slidably engageable with the lamp post of the light fixture. The stabilizing base includes a frustoconical support section that includes at least one slot through which is laced one of a plurality of fastening straps. The fastening straps are each fastened to the balloon. As such, the balloon may be fastened securely to the mast through the fastening straps and the stabilizing base, and wind load on the balloon is thereby transferred to the mast and the base without adversely affecting the light fixture inside the balloon. Means are provided for keeping the balloon material away from the bulb in case the balloon deflates, such as if punctured.

A power source is provided that is totally containable in the enclosure. The ballast means includes at least one ballast extension cord for electrically connecting the power source to the connector cable through a connector thereof. As such, the bulb may be illuminated by connecting a suitable number of ballast extension cords to connect to the connector of the connector cable, and then activating the power source. Further, an air blower may be included in the enclosure that is adapted to cooperate with the one-way air valve of the port plug such that, when power is applied to the air blower, the air blower moves air from outside of the balloon into the balloon, thereby inflating the balloon.

The device is easily assembled and disassembled by following the steps discussed in detail in the detailed description, below. The present invention provides a portable lighting apparatus that provides essentially silent operation while still providing high-intensity illumination for a large area, yet does not result in glare that is often caused by direct high-intensity lighting. The present apparatus is easy to store and transport, and is made from relatively inexpensive and light-weight components. Further, the present device is adjustable to a variety of heights, allows for a wide variety of uses both indoors and outdoors, and does not require roadway access to the desired location of use. Still further, the present device is safe for extended use and versatile in its mounting configurations. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an exploded rear elevational view of the invention, illustrating the components of one embodiment of the portable lighting apparatus of the present invention;

FIG. 2 is a rear elevational view of a light fixture and light bulb of the present invention;

FIG. 3 is a partially cut-away elevational view of a preferred embodiment of an illuminated balloon of the present invention;

FIG. 4 is a perspective view of a mast segment of the present invention;

FIG. 5A is a side elevational view of a mounting post of the present invention, illustrating a top portion pivotably attached to a bottom portion thereof, the top portion shown in a horizontal orientation and ready to receive a lower end of one of the mast sections;

FIG. 5B is a side elevational view of the mounting post of FIG. 5A, illustrating the lower end of one of the mast sections as engaged with the top portion of the mounting post, the bottom portion of the mounting post preventing the further engagement of the one mast section with the mounting post;

FIG. 5C is a side elevational view of the mounting post of FIG. 5B, illustrating the top portion of the mounting post in a vertical orientation, co-aligned with the bottom portion of the mounting post, the one of the mast sections fully engaging the mounting post and supported by a backstop of the mounting post;

FIG. 6 is a perspective view of an open port assembly of the balloon of the present invention;

FIG. 7 is a perspective view of a circular disk of one embodiment of the invention;

FIG. 8 is a perspective view of a rubber gasket of the invention, used in the open port assembly to provide an air-tight seal between the balloon and the open port assembly;

FIG. 9 is an exploded cross-sectional view of the open port assembly, taken generally across lines 9-9 of FIG. 6, illustrating in more detail how an opening of the balloon is hermetically sealed to the open port assembly;

FIG. 10 is an exploded perspective view of a base of one embodiment of the invention, illustrating a preferred enclosure thereof; and

FIG. 11 is a partial perspective view, taken generally along line 11 of FIG. 10, illustrating a mast opening of one side of the enclosure of FIG. 10.

### DETAILED DESCRIPTION OF THE PREFERRED EMBODIMENT

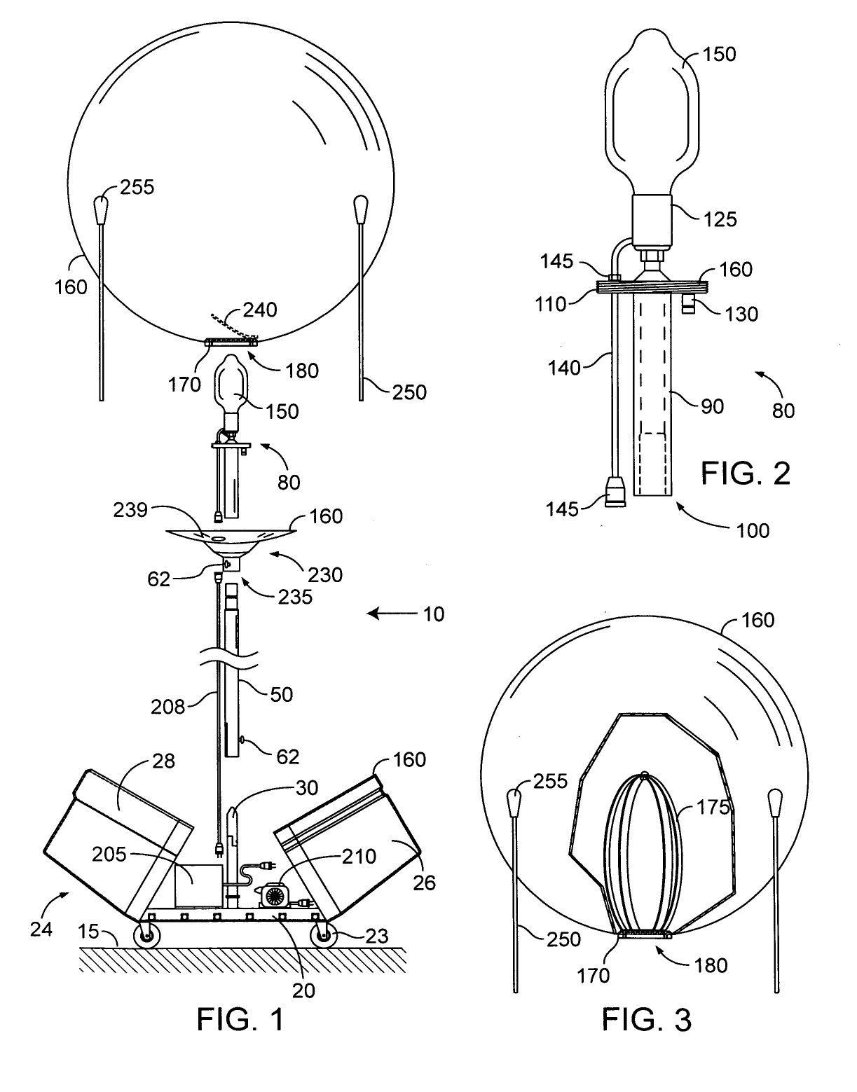

FIG. 1 illustrates a portable lighting apparatus 10 suitable for use at an outdoor construction site, underground tunnel, or other open area where temporary illumination is desired. The apparatus 10 includes a base 20 for supporting a mounting post 30 (FIG. 11). The base 20 may be, in its simplest form, a metal plate suitable for welding or otherwise fixing to a vehicle, a building structure, or the like.

In the preferred embodiment of the invention, however, the base 20 is preferably made from a rigid metallic material such as aluminum, and is preferably powder coated on at least a bottom side 19 thereof. The base 10 includes a plurality of wheels 23 fixed to the bottom side 19, and the preferred embodiment of the invention includes two caster swivel wheels with locks (locks not shown) and two caster swivel wheels without locks, such that the apparatus 10 may be easily rolled along a ground surface 15 and then locked in place by engaging the locks on the lockable wheels 23. The mounting post 30 is fixed to the base 20 with a mounting plate 17 (FIG. 1) that is bolted to the base 20, welded thereto, or fixed in some other permanent manner.

Also in the preferred embodiment, the base 20 includes an enclosure 24, openably attached to a top side 21 of the base 20. The enclosure 24, when in a closed configuration, completely encloses the mounting post 30, as well as the other components of the invention when the apparatus 10 is in a disassembled configuration. As best illustrated in FIG. 11, the preferred mode of the enclosure 24 includes a left enclosure half 26 hingably attached at one side thereof to one side 25 of the base 20, and a right enclosure half 28 hingably attached at one side thereof to an opposing side 27 of the base. The left and right enclosure halves 26,28 cooperate together to allow access to inside the enclosure 24 when in an open configuration, and to substantially seal the enclosure 24 against weather elements when in the closed configuration. The left and right enclosure halves 26,28 are preferably made from a rigid plastic or fiberglass material, suitable for extended outdoor use. Further, the left and right enclosure halves 26,28 each have cooperating mast openings 29 for allowing the protrusion of a mast 40 from within the enclosure 24. As such, with the left and right enclosure halves 26,28 in a closed configuration, additional lateral support is provided to the mast 40 protruding from the enclosure 24 and held by the edges of the mast openings 29.

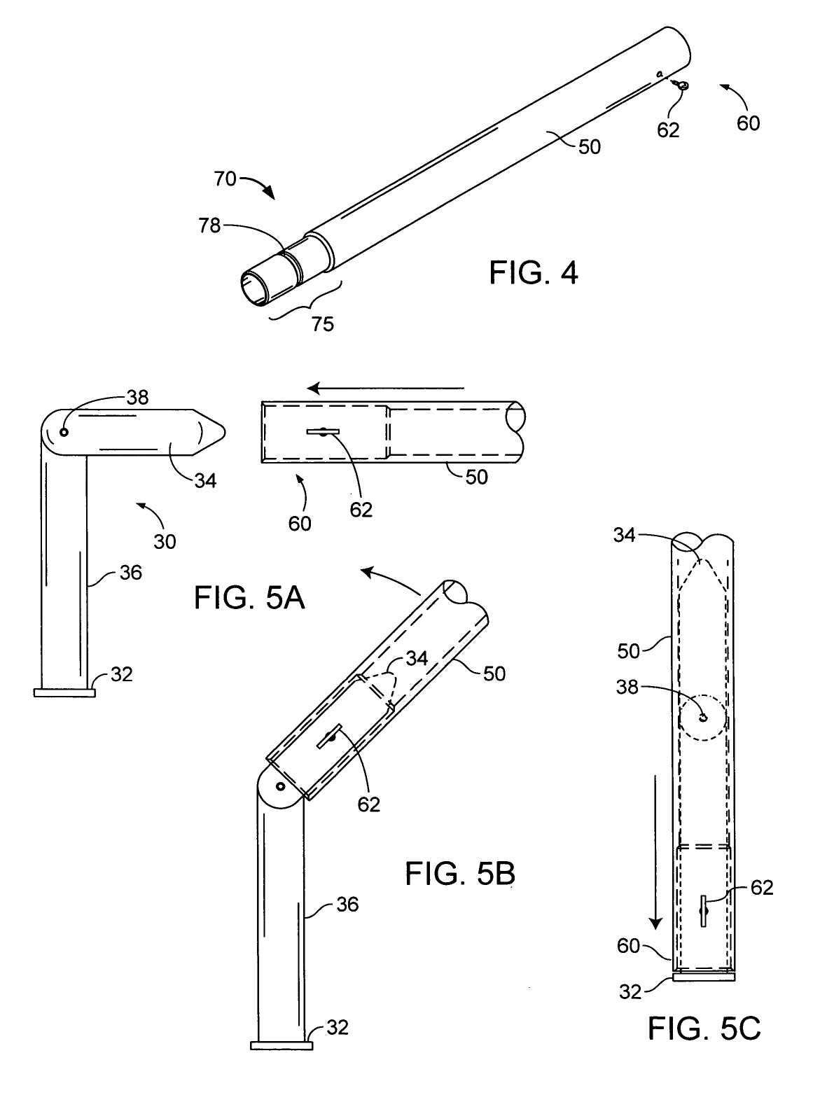

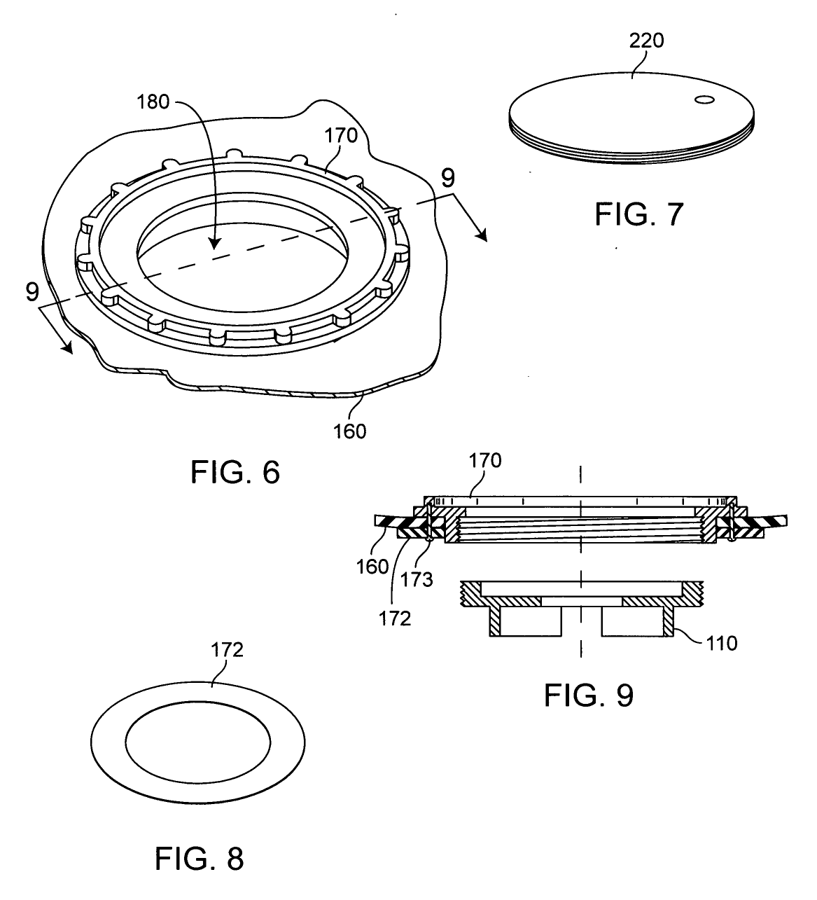

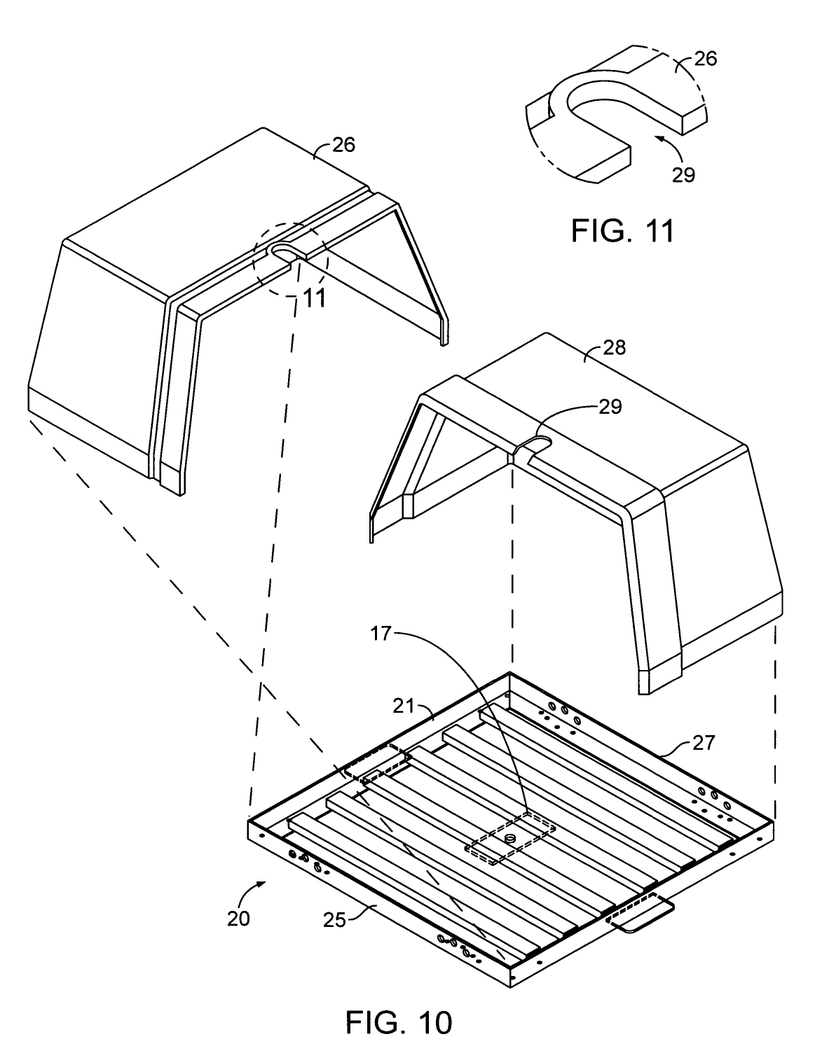

FIGS. 1 and 4 illustrate the mast 40 in more detail. The mast 40 is preferably comprised of a plurality of elongated mast sections 50 (FIG. 4) formed from generally cylindrical metal pipe or other rigid material. Each mast section 50 includes a lower end 60 that is open at the end thereof and includes a thumbscrew 62. Each mast section 50 further includes an upper end 70 that includes a grooved section 75 that is smaller in diameter than the inside diameter of each lower end 60. The grooved section 75 includes an annular groove 78. To assemble the mast 40 a number of elongated mast sections 50 are assembled lower end 60 to upper end 70. The grooved section of the lower-most mast section 50 is inserted into the lower end 60 of the next higher mast section 50, and the thumbscrew 62 of the next higher mast section 50 is tightened such that it engages the groove 78 of the lower-most mast section 50, fixing the two together. Assembly continues in this manner until the desired height of mast 40 is obtained.

Alternately, the mast 40 may be made from a series of telescoping mast sections (not shown), as is known in the prior art. Yet another alternate embodiment of the mast 40 may be a series of pivotably connected mast segments made from square cross-section tubing, or the like, that are coaxially lockable. Clearly, there are a variety of mast 40 embodiments that may be used, some of which are known in the art.

Referring to FIGS. 5A, 5B, and 5C, the mounting post 30 of the base 20 preferably includes a top portion 34 pivotally attached to a bottom portion 36 thereof via a pivot means 38. As such the top portion 34 is pivotable between a generally horizontal orientation, as best illustrated in FIG. 5A, and a generally vertical orientation, as best illustrated in FIG. 5C. In use, the lower end 60 of the lower-most mast segment 50 of the mast 40 is positioned around the top portion 34 of the mounting post 30, such that the mast 40 is maintained in a generally horizontal position. When the user is ready to raise the mast 40, as in an assembly method explained in more detail below, the top-most end of the mast 40 is raised, pivoting the top portion 34 (FIG. 5B), until the top portion 34 is substantially vertical (FIG. 5C). As such, the mast 40 drops down until it contacts the backstop 32. The rigidity of the lower-most mast segment 50 prevents further pivoting of the mounting post 30, thereby maintaining the mast 40 in a generally orthogonal orientation to the base 20. Assuming the base 20 is resting upon generally level ground 15, the mast 40 is maintained in a generally vertical orientation. In the simplest embodiment, the backstop 32 is not included, whereby the function of the backstop 32 is provided by the base 20.

The present invention further includes a light fixture 80 that comprises a lamp post 90, a port plug 110, and a lamp holder mount 120 that supports a lamp holder 125 (FIG. 2). The lamp post 90 has a lower end 100 that is fixably engageable with the upper end 70 of any one of the plurality of mast sections 50. The port plug 110 is a generally circular disk that includes a one-way air valve 130, as well as support for the lamp holder mount 120 and the lamp post 90. The port plug is preferably injection molded of a plastic material, or fashioned from another suitably rigid and air-tight material. Other than for the one-way air valve 130, the port plug 110 as an assembly is impermeable to air. A lamp bulb 150 is held by the lamp holder 125, and a connector cable 140 is electrically connected to the bulb 150 through the lamp holder 125. The connector cable 140 passes through the port plug 110 in an air-tight fashion. A cable seal 145, such as a rubber grommet, may be included to ensure an air-tight seal of the connector cable 140 through the port plug 110.

A unitary inflatable non-opaque balloon 160 is included that comprises a flexible, generally spherical sheet material and an open port 170. The open port 170 provides an opening 180 into the balloon for hermetically receiving the light fixture 80 therein. In the preferred embodiment of the invention, the balloon 160 is made from a unitary piece of vinyl material and is initially either rotationally molded or blow molded. The balloon 160 is removed from the mold and, while the vinyl material is still hot or warm, the balloon 160 is subsequently filled with air to further expand the balloon 160.

In one embodiment of the invention, the balloon 160 is expanded to a size of greater than 18 inches, with a wall thickness of between 0.035 and 0.065 inches. As such, the balloon 160 is formed as an air-tight balloon with the exception of the open end 180. When deflated, the balloon 160 may be stored in a rolled configuration (not shown) and stored completely within the closed enclosure 24.

The open port 170 preferably includes a biased cage 175 that is naturally biased in an open configuration and large enough to receive the light fixture 80 therein without contacting the bulb 150 (FIG. 3). Such a cage 175 may be rolled-up with the balloon 160, the sides thereof temporarily deforming into a collapsed configuration (not shown) for storage thereof. However, upon unfolding of the deflated balloon 160 the metal cage springs open to receive the light fixture 80. The cage 175 may be made of a plurality of loops of metallic strips or other material capable of withstanding intense heat from the bulb 150. Preferably, however, the cage 175 is made from a transparent or translucent material, such as high-temperature resistant plastic or fiberglass, whereby interior shadows on the balloon 160 are minimized.

In an alternate embodiment of the invention, illustrated in FIG. 1, a flexible flap 240 is included on the inside of the balloon 160 (FIG. 1), the flexible flap 240 normally in a closed position to substantially reduce airflow out of the balloon 160.

A stabilizing base 230 is preferably included and is illustrated in FIG. 1. The stabilizing base 230 includes a center opening 235 slidably engageable with the lamp post 90 of the light fixture 80. The stabilizing base 230 includes a frustoconical support section 238 that includes at least one slot 239 through which is laced one of a plurality of fastening straps 250. The fastening straps 250 are each fastened to the balloon 160 with a hanging means 255 that is adhered or otherwise fixed to the balloon 160. The hanging means is preferably made from PVC. As such, the balloon 160 may be fastened securely to the mast 40 through the fastening straps 250 and the stabilizing base 230. Wind load on the balloon 160 is thereby transferred to the mast 40 and the base 20 without adversely affecting the light fixture 80 inside the balloon 160. The metal cage 175 further prevents the balloon 160 from coming into contact with the bulb 150.

A power source 200, preferably a ballast means 205, may be additionally provided, and totally enclosable in the enclosure 24. The ballast means 205 includes at least one ballast extension cord 208 for electrically connecting the power source 200 to the connector cable 140 through a connector 145 thereof. The connector 145 is preferably waterproof and able to prevent shorting of the electrical connections therein in inclement weather conditions. As such, the bulb 150 may be illuminated by connecting a suitable number of ballast extension cords 208 to connect to the connector 145 of the connector cable 140, and then activating the power source 200.

Further, an air blower 210 (FIG. 1) may be included in the enclosure 24 that is adapted to cooperate with the one-way air valve 130 of the port plug 110 such that, when power is applied to the air blower 210, the air blower 210 moves air from outside of the balloon 160 into the balloon 160, thereby inflating the balloon.

In the embodiment of the invention without the metal cage 175, a circular disk 220 may be further included to fit snuggly into the open port 170 of the balloon, the circular disk 220 having an opening that cooperates with the air blower 210 to allow air to be blown into the balloon 160, thereby reducing the amount of air that simultaneously escapes the balloon 160 when the air blower 210 is active. Preferably, in such an embodiment, the circular disk 220 is attached to the air blower 210 so that it will not become lost therefrom (not shown).

Reflector elements may be included (not shown) towards a top side of the balloon for reflecting light from the bulb 150 down towards the ground 15. As such, the top portion of the balloon 160 is not illuminated, and the efficiency of the illumination of the ground 15 is increased.

In operation, a user rolls the portable lighting apparatus 10 onto an area of ground 15 that the user desires to illuminate. Such an area may be outside at a construction project, for example, or inside such as in a large ballroom, sporting arena, or other open area. All of the components of the apparatus 10 may be enclosed in the enclosure 24. When opened, the components may be laid on the ground 15 nearby to facilitate assembly.

The user assembles the light bulb 150 to the light fixture 80 by either screwing the bulb 150 into the lamp holder 125, or by other suitable means, depending upon the type of bulb 150 and lamp holder 125 used. Preferably the bulb 150 is of the type having threads for screwing into a threaded lamp holder 125. In certain embodiments wherein the apparatus is to be used outside, a relatively bright 110,000 lumen metal halide bulb may be used to simulate sunlit conditions and allow users excellent visibility. Such a bulb 150 has an explosion-resistant jacket (not shown) and is UL listed. Preferably such an embodiment also includes a balloon 160 that is over 42″ in diameter, providing ample air circulation to transmit heat away therefrom.

In the embodiment of the invention without the metal cage 175 in the balloon 160, with the balloon deflated, the user inserts the circular disk 220 of the air blower 210 into the open port 170 and activates the air blower until the balloon 160 is at least partially inflated, preferably over 50% inflated. The circular disk 220 is removed, and due to the air pressure inside the balloon 160, the flexible flap 240 is pressed against the opening 180 of the balloon and substantially prevents the balloon 160 from quickly deflating. With either the balloon 160 partially inflated, or the metal cage 175 providing an open area within the balloon 160 for the light fixture 80, the light fixture 80 is then inserted through the opening 180 and the port plug 110 is engaged with the open port 170 of the balloon in an air-tight fashion. Preferably the open port 170 includes a threaded inner diameter that cooperates with a threaded outer diameter of the of port plug 110 to effect the hermetic seal of the balloon 160. At this point the balloon 160 is fully inflated by engaging the air blower 210 with the one-way air value 130 of the port plug 110. The balloon 160 rests on the ground 15 with the lamp post 90 protruding therefrom generally horizontally.

Next the stabilization base 230 is slid onto the lamp post 90 to cover the open port 170 and the air valve 130 and is pressed against the balloon 160. The stabilization base 230 is secured to the lamp post 90 by tightening a thumb screw 6 (FIG. 1). As the balloon 160 is hermetically sealed, there is no need to continue to re-inflate the balloon 160 during use, so access to the valve 130 is unnecessary. The fastening straps 250 are secured to the slots 239 of the stabilization base 230 and tightened, thereby securing the light fixture 80 inside the balloon 160 in such a way as that movement of the balloon 160, such as by wind force, will not cause the light fixture 80 to move.

At least one of the mast sections 50 is selected, depending upon the user's desired height of the balloon 160. By way of example, if the desired height is eight feet, and each mast section is roughly two feet, then four mast sections 50 may be assembled together to form the eight foot mast 40. The mast sections 50 are assembled by inserting the upper end 70 of one mast section 50 into the lower end 60 of another next mast section 50 and tightening the thumbscrew 62 of the next mast section 50. When the mast 40 has been assembled the lower end 60 of the lower-most mast section 40 is positioned around the horizontally oriented top portion 34 of the mounting post 30 (FIG. 5A). The upper end 70 of the upper most mast section 50 is inserted into the open end of the lamp post 90. One of the thumb screws 62 may be included with the lamp post 90 to fix the lamp post 90 onto the mast 40. As such, the balloon 160, resting on the ground 15, supports the mast 40 in cooperation with the mounting post 30 in a generally horizontal orientation.

Next, the electronic ballast means 205 is connected to the connector cord 140 by way of a suitable number of ballast extension cords 208, preferably only one. The mast 40 with the balloon 160 is then raised up (FIG. 5B) until it is essentially vertical (FIG. 5C), whereupon the mast 40 may be completely slid over the mounting post 30, past the pivot means 38 thereof, until it contacts the backstop 32. As such the mast 40 is locked into a generally perpendicular orientation with respect to the base 20, the pivot means 38 being unable to pivot. The balloon 160 is thereby positioned at the desired height above the ground 15.

The ballast means 205 is then activated, after supplying it with a suitable power source, to illuminate the bulb 150. Air currents within the balloon 160 circulate and provide cooling to the bulb 150. The ballast means 205 is preferably noiseless, so that operation of the portable lighting apparatus 10 is essentially silent.

To disassemble the portable lighting apparatus 10, the ballast means 205 is deactivated and the bulb 150 is allowed to cool. The reverse of the process outlined above is then followed to disassemble the components, all of which can be stored within the enclosure and rolled into a suitable storage area or otherwise stowed.

While a particular form of the invention has been illustrated and described, it will be apparent that various modifications can be made without departing from the spirit and scope of the invention. For example, the exact nature of the base 20 may vary depending upon the application. The base 20 may be mounted to a wall, for instance, of an outdoor parking garage to provide illumination to the surrounding parking areas. Or the base 20 may be mounted to a vehicle or a lifeguard tower. Indeed, the base 20 may be mounted vertically and the mast 40 may project horizontally over an area to be illuminated. In such an embodiment the heat of the bulb would require the lamp holder mount 120 to support the bulb more centrally within the balloon 160. Likewise, different sized balloons 160 may be used in various applications, some of which require a large balloon 160 due to the intensity of the bulb 150 being used, and others requiring relatively smaller balloons 160 when lower intensity or cooler bulbs 150 are used. Accordingly, it is not intended that the invention be limited, except as by the appended claims.

What is claimed is:

1. A portable lighting apparatus comprising:
a base for supporting a mounting post,
a mast comprising at least one elongated mast section, each mast section including a lower end and an upper end, the lower end of each mast sections fixably engagable with the mounting post,
a lamp bulb,
a light fixture comprising a lamp post having a lower end fixably engageable with the upper end of each of the mast sections, a port plug, a lamp holder mount for supporting a lamp holder, the port plug including a one-way air valve, the lamp holder including a connector cable electrically connectable to the lamp bulb when the lamp bulb is retained in the lamp holder, and
a unitary inflatable non-opaque balloon comprising a flexible, generally spherical sheet material and an open port, the open port providing an opening in the balloon for hermetically receiving the light fixture therein,
whereby with the light fixture inserted into the open port of the balloon and hermetically sealed therein, the balloon inflated, the lamp bulb engaged with the lamp holder, and with the lamp post mounted to at least one of the mast sections as the mast, the bottom-most mast section being engaged with the mounting post of the base, the bulb may be connected to a suitable power source through the connector cable to illuminate the bulb and thereby illuminate the balloon.

2. The portable lighting apparatus of claim 1 wherein the base includes a metal plate for fixing to a vehicle.

3. The portable lighting apparatus of claim 1 wherein base further includes a plurality of wheels on a bottom side thereof.

4. The portable lighting apparatus of claim 1 wherein the base further includes an enclosure openably attached to a top side thereof, the enclosure encompassing the mounting post when the enclosure is in a closed configuration.

5. The portable lighting apparatus of claim 4 wherein the enclosure comprises a left enclosure half hingably attached at one side thereof to one side of the base, and a right enclosure half hingably attached at one side thereof to an opposing side of the base, the left and right enclosure halves when in a closed configuration cooperating together to form the generally sealed enclosure on the top side of the base, the left and right enclosure halves each further providing a mast opening for further supporting the mast when the mast is mounted on the mounting post and the left and right enclosure halves are each in the closed configuration.

6. The portable lighting apparatus of claim 1 wherein the base further includes:
an electronic ballast means positionable inside the enclosure, and
at least one ballast extension cord, the ballast connection cord for electrically connecting the connector cable of the lamp holder with the electronic ballast means when the portable lighting apparatus is in a fully assembled configuration.

7. The portable lighting apparatus of claim 1 wherein the base further includes a removable air blower fully storable within the enclosure when the enclosure is in the closed configuration, the air blower adapted for blowing air through the one-way air valve of the port plug.

8. The portable lighting apparatus of claim 7 wherein the air blower further includes a circular disk for hermetically attaching to the open port of the balloon, whereby the balloon may be at least partially inflated by attaching the circular disk to the open port of the balloon, attaching the air blower to the circular disk, and then activating the air blower for blowing air from outside of the balloon to a space inside the balloon.

9. The portable lighting apparatus of claim 1 wherein the mounting post includes a top portion pivotally attached to a bottom portion, the bottom portion further including a backstop, the top portion pivotable between at least a substantially horizontal orientation and a substantially vertical orientation.

10. The portable lighting apparatus of claim 1 wherein each mast segment includes a grooved section at the lower end thereof and a thumb screw proximate to the upper end thereof, the grooved section formed with a diameter small enough so as to be slidably engageable with the upper end of another such mast segment, such that the thumb screw of the another such mast segment may be aligned with the groove of the one mast segment so that when the thumbscrew is tightened the one and another mast segments are fixedly attached together.

11. The portable lighting apparatus of claim 1 further including a stabilizing base, the stabilizing base slidably and fixedly attachable to the lamp post through a center opening thereof such that a frustoconical support section of the stabilizing base supports the balloon when the balloon is inflated.

12. The portable lighting apparatus of claim 1 wherein the balloon includes a resilient flap internal to the balloon such that when the light fixture is not assembled to the balloon, the resilient flap closes the open port of the balloon hermetically.

13. The portable lighting apparatus of claim 11 wherein the balloon includes a plurality of fastening straps for maintaining the balloon on the stabilizing base, the stabilizing base further including a plurality of notches each for retaining one of the fastening straps.

14. The portable lighting apparatus of claim 1 wherein the balloon is made of a vinyl material having a thickness between 0.035 inches and 0.065 inches.

15. The portable lighting apparatus of claim 1 wherein the balloon is at least 18″ in diameter when fully inflated.

16. A method of illuminating an area of ground comprising the steps of,
(a) providing a portable lighting apparatus as recited in claim 1, the portable lighting apparatus in an at least partially disassembled configuration,
(b) inserting the light fixture into the balloon in a hermetical fashion,
(c) assembling the mast of the portable lighting apparatus by engaging a plurality of the mast sections together to achieve a desired height of the mast,
(d) assembling the light fixture and balloon to the mast,
(e) mounting the lower-most end of the mast to the mounting post of the base, and
(f) connecting suitable power to the connector cable to illuminate the bulb.

17. The method of claim 16 further including after step (a) the step of
(a2) at least partially inflating the balloon of the portable lighting apparatus.

18. A method of illuminating an area of ground comprising the steps of,
(a) providing a portable lighting apparatus as recited in claim 9, the portable lighting apparatus in an at least partially disassembled configuration with the base thereof resting on the area of ground,
(b) inserting the light fixture into the balloon in a hermetical fashion,
(c) assembling the mast of the portable lighting apparatus by engaging a plurality of the mast sections together to achieve a desired height of the mast,
(d) assembling the lower-most end of the mast of the portable lighting apparatus to the mounting post of the base, the mounting post being in a generally horizontal orientation,
(e) assembling the light fixture and balloon to the mast,
(f) pivoting the mast around the mounting post pivot until the mounting post achieves a generally vertical orientation, the mast then sliding down the mounting post to lock the mounting post in the vertical orientation, and
(g) connecting suitable power to the connector cable to illuminate the bulb.

19. The method of claim 18 further including after step (a) the step of
(a2) at least partially inflating the balloon of the portable lighting apparatus.

20. A method of illuminating an area of ground comprising the steps of,
(a) providing a portable lighting apparatus as recited in claim 11, the portable lighting apparatus in an at least partially disassembled configuration with the base thereof resting on the area of ground,
(b) providing a volume within the balloon of the portable lighting apparatus capable of receiving the light fixture,
(c) inserting the light fixture into the balloon in a hermetical fashion,
(d) sliding the stabilizing base onto the lamp post until the stabilizing base contacts the balloon,
(e) tightening the thumb screw of the stabilizing base to retain the stabilizing base against the balloon and on the lamp post,
(f) assembling the mast of the portable lighting apparatus by engaging a plurality of the mast sections together to achieve a desired height of the mast,
(g) assembling the light fixture and balloon to the mast,
(h) mounting the lower-most end of the mast to the mounting post of the base, and
(i) connecting suitable power to the connector cable to illuminate the bulb.
